(19) United States
(12) Patent Application Publication
(10) Pub. No.: US 2016/0072191 A1
(43) Pub. Date: Mar. 10, 2016

(54) ARRAY ANTENNA DEVICE AND RADIO COMMUNICATION DEVICE

(71) Applicant: Panasonic Corporation, Osaka (JP)

(72) Inventors: HIROSHI IWAI, Kanagawa (JP); JUNJI SATO, Tokyo (JP); RYOSUKE SHIOZAKI, Tokyo (JP); JIRO HIROKAWA, Tokyo (JP); MIAO ZHANG, Tokyo (JP)

(21) Appl. No.: 14/842,880

(22) Filed: Sep. 2, 2015

(30) Foreign Application Priority Data
Sep. 5, 2014 (JP) 2014-181569

(51) Int. Cl. H01Q 13/10; H01Q 1/50; H01Q 1/24

(52) U.S. Cl. CPC H01Q 13/10; H01Q 1/24; H01Q 1/50

(57) ABSTRACT

An array antenna device includes a plurality of slot array antennas which are arranged and each of which includes a plurality of slot antennas and a radiation surface, which is formed to be conformal, and a plurality of waveguides each of which supplies respective power to each of the slot array antennas. After bodies of the waveguides are formed by a resin molding method, surface treatment is performed with respect to inner surfaces of the waveguides with plating.

### BACKGROUND

1. Technical Field

The present disclosure relates to an array antenna device such as a conformal waveguide slot array antenna device and a radio communication device using the array antenna device.

2. Description of the Related Art

An example of a conformal antenna is disclosed in Japanese Unexamined Patent Application Publication No. 63-031304, for example. This conformal antenna is characterized in that “in an antenna device including an antenna base which has a desired curved surface, microstrip antennas which are attached in a predetermined pitch on an outer circumference of the base, and a power supply circuit which is disposed in one of an inside and an outside of the antenna base and supplies a radio wave to the microstrip antennas, a thickness of radiation conductor elements, among a dielectric substrate, a plurality of pieces of connectors, and the radiation conductor elements constituting the microstrip antenna, is changed so as to form a part of the curved surface of the antenna base by an external surface of the radiation conductor elements”. An array antenna, in which radiation elements are arranged on a plane having curvature similar to that of a body of an airplane, for example, is generally called a conformal antenna.

Further, Japanese Unexamined Patent Application Publication No. 7-176948 discloses that a waveguide slot antenna is used as a conformal array antenna in which radiation elements are arranged on a surface of a triangular pyramid or a sphere or a curved surface like a body of an airplane, for example. Here, a conformal waveguide slot array antenna is constituted by forming a plurality of slots on a single waveguide and an upper metal plate and a lower metal plate of a single waveguide is formed in a circular-arc shape.

Further, Japanese Unexamined Patent Application Publication No. 6-188925 and Japanese Unexamined Patent Application Publication No. 7-106847 disclose a leaked-wave waveguide cross slot array antenna in which a plurality of cross slots are formed on a wide wall of a rectangular waveguide along a propagation direction of radio waves.

### SUMMARY

A manufacturing process of the conformal antenna disclosed in Japanese Unexamined Patent Application Publication No. 63-031304, for example, is simple because the conformal antenna is composed of a planar antenna which is formed on a substrate. However, compared to the waveguide array antennas which are disclosed in Japanese Unexamined Patent Application Publication Nos. 7-176948, 6-188925, and 7-106847, the cost of a dielectric material for low loss is high and it is difficult to increase a radiation angle.

One non-limiting and exemplary embodiment provides an array antenna device which is capable of radiating a radio wave in lower loss and increasing a radiation angle, and which can be more simply manufactured, compared to a conformal antenna composed of a planar antenna.

In one general aspect, the techniques disclosed here feature an array antenna device which includes a plurality of slot array antennas which are arranged and each of which includes a plurality of slot antennas and a radiation surface, the radiation surface having a conformal shape, and a plurality of waveguides each of which supplies respective power to each of the plurality of slot array antennas.

It should be noted that general or specific embodiments may be implemented as a system, a method, an integrated circuit, a computer program, a storage medium, or any selective combination thereof.

The array antenna device according to one aspect of the present disclosure is capable of radiating a radio wave in lower loss and increasing a radiation angle, compared to a conformal antenna which is composed of a planar antenna.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a perspective view illustrating an external appearance of a conformal waveguide slot array antenna device according to Embodiment 1;

FIG. 2 is a lateral view illustrating the configuration of the conformal waveguide slot array antenna device of FIG. 1 and a peripheral circuit of the conformal waveguide slot array antenna device;

FIG. 3 is a longitudinal sectional view illustrating a conformal waveguide slot array antenna device according to a first modification;

FIG. 4 is a plan view of a conformal waveguide slot array antenna device according to a second modification;

FIG. 5 is a plan view of a conformal waveguide slot array antenna device according to a third modification;

FIG. 6 is a bottom view illustrating a power supply portion provided on a bottom surface of the conformal waveguide slot array antenna device of FIG. 1;

FIG. 7 is a plan view illustrating an upper surface of an integrated circuit (IC) of FIG. 2 and FIG. 3;

FIG. 8 illustrates a radiation pattern of the conformal waveguide slot array antenna device of FIG. 1 and a radiation pattern of a waveguide slot array antenna device of a comparative example;

FIG. 9 is a longitudinal sectional view illustrating the configuration of a case in which the conformal waveguide slot array antenna device of FIG. 1 is manufactured by a resin molding method;

FIG. 10 is a lateral view illustrating an element interval of the conformal waveguide slot array antenna device of FIG. 1;

FIG. 11 is a lateral view for explaining that guide wavelengths are made even in each waveguide of the conformal waveguide slot array antenna device of FIG. 1;

FIG. 12 is a perspective view illustrating an external appearance of a radar device according to Embodiment 2;

FIG. 13 is a block diagram illustrating the configuration of a radio transmission circuit for a transmission antenna of FIG. 12; and

FIG. 14 is a block diagram illustrating the configuration of a radio reception circuit for a reception antenna of FIG. 12.

### DETAILED DESCRIPTION

Embodiments according to the present disclosure are described below in reference to the accompanying drawings. Here, constituent elements equivalent to each other are given an identical reference character in the following embodiments.

### Embodiment 1

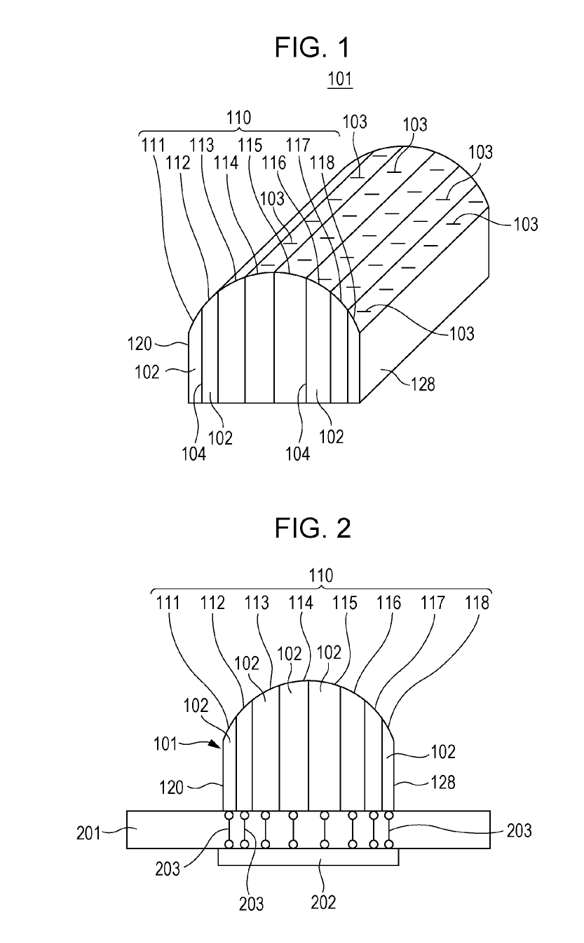

FIG. 1 is a perspective view illustrating an external appearance of a conformal waveguide slot array antenna device 101 according to Embodiment 1. The conformal waveguide slot array antenna device 101 according to the present embodiment is composed of a plurality of slot array antennas which are arranged. Each of the plurality of slot array antennas includes a plurality of slot antennas 103 which are formed on each of narrow wall surfaces 111 to 118 constituting a radiation surface 110 which is formed in a conformal shape to have curvature like that of a body of an airplane, for example. Here, the radiation surface 110 is composed of a plurality of narrow wall surfaces 111 to 118 which have a rectangular flat plate shape, for example. The lower portion of the radiation surface 110 is composed of a plurality of rectangular waveguides 102 which are separated by lateral walls 104 between lateral wide wall surfaces 120 and 128. A radio signal supplied to each of the rectangular waveguides 102 is propagated inside the waveguides 102 and is radiated from the slot array antenna composed of a plurality of slot antennas 103.

Formation of the slot antennas 103 shown in FIG. 1 will be described later.

FIG. 2 is a lateral view illustrating the configuration of the conformal waveguide slot array antenna device 101 of FIG. 1 and a peripheral circuit of the conformal waveguide slot array antenna device 101. A power supply portion positioned on the lower portion of each of the waveguides 102 of the conformal waveguide slot array antenna device 101 is coupled with an integrated circuit (IC) 202 which includes a radio wave transmission/reception circuit via a power supply line 203. The power supply line 203 is provided in a substrate 201 which is disposed on the lower portion of the conformal waveguide slot array antenna device 101. A radio signal outputted from the integrated circuit 202 is radiated from a plurality of antennas which are provided on the radiation surface 110 via a plurality of power supply lines 203 and a plurality of waveguides 102. On the other hand, a radio signal received by a plurality of antennas provided on the radiation surface 110 is outputted to the integrated circuit 202 via a plurality of waveguides 102 and a plurality of power supply lines 203.

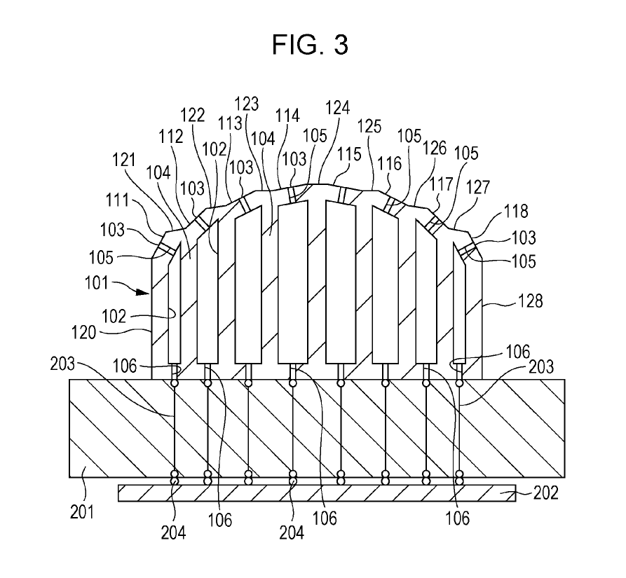

FIG. 3 is a longitudinal sectional view illustrating a conformal waveguide slot array antenna device according to a first modification. In the conformal waveguide slot array antenna device according to the first modification, adjacent narrow wall surfaces, among the narrow wall surfaces 111 to 118 which are respectively opposed to narrow wall surfaces of a plurality of waveguides 102, are coupled by connection surfaces 121 to 127 respectively so as to form a radiation surface 110. Here, the narrow wall surface 111 is coupled to the narrow wall surface 112 with the connection surface 121 interposed therebetween, the narrow wall surface 112 is coupled to the narrow wall surface 113 with the connection surface 122 interposed therebetween, and the narrow wall surface 113 is coupled to the narrow wall surface 114 with the connection surface 123 interposed therebetween. The narrow wall surface 114 is coupled to the narrow wall surface 115 with the connection surface 124 interposed therebetween, the narrow wall surface 115 is coupled to the narrow wall surface 116 with the connection surface 125 interposed therebetween, the narrow wall surface 116 is coupled to the narrow wall surface 117 with the connection surface 126 interposed therebetween, and the narrow wall surface 117 is coupled to the narrow wall surface 118 with the connection surface 127 interposed therebetween.

In FIG. 3, power supply portions 105 which propagate a radio signal are provided between the narrow wall surfaces 111 to 118 of the radiation surface 110 and the waveguides 102 respectively and power supply portions 106 which propagate a radio signal are provided between the lower portions of the waveguides 102 and the power supply lines 203 respectively. Further, connection terminals 204 of the integrated circuit 202 are connected to the power supply lines 203 respectively. Here, a plurality of waveguides 102 are separated from each other by lateral walls 104. A radio signal outputted from the integrated circuit 202 is radiated from a plurality of slot antennas which are provided on the radiation surface 110, via a plurality of connection terminals 204, a plurality of power supply lines 203, a plurality of power supply portions 106, a plurality of waveguides 102, and a plurality of power supply portions 105. On the other hand, a radio signal received by a plurality of slot antennas which are provided on the radiation surface 110 is outputted to the integrated circuit 202, via a plurality of power supply portions 105, a plurality of waveguides 102, a plurality of power supply portions 106, a plurality of power supply lines 203, and a plurality of connection terminals 204.

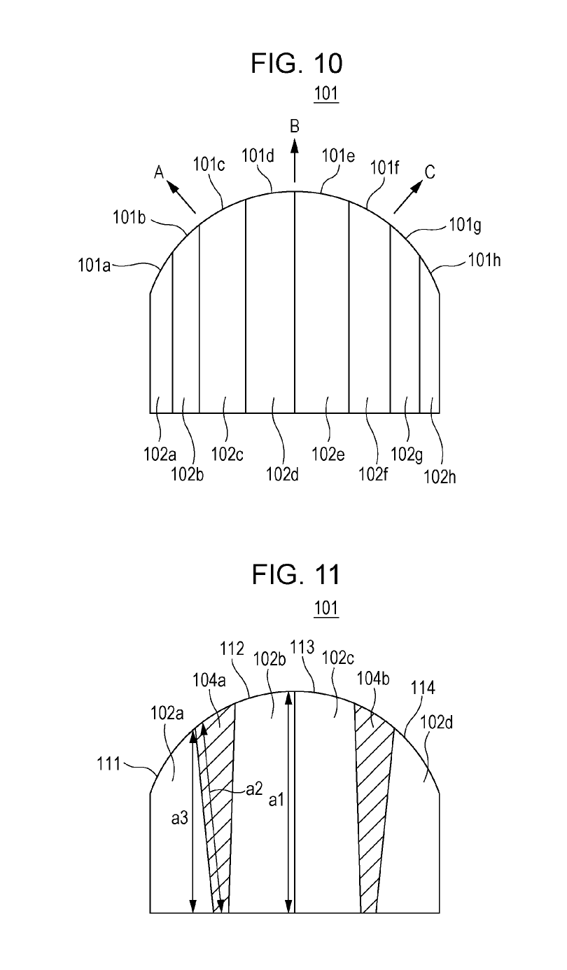

In the conformal waveguide slot array antenna device of FIG. 3, a slot array antenna is formed on the narrow wall surfaces 111 to 118 which are opposed to the narrow wall surfaces of the waveguides 102 and a plurality of narrow flat plates which respectively have the narrow wall surfaces 111 to 118 are coupled to each other on connection surfaces so as to form the radiation surface 110 having the conformal shape. Accordingly, a wider angle is attained compared to a planar antenna of examples of related art, as described in detail below with reference to FIG. 10.

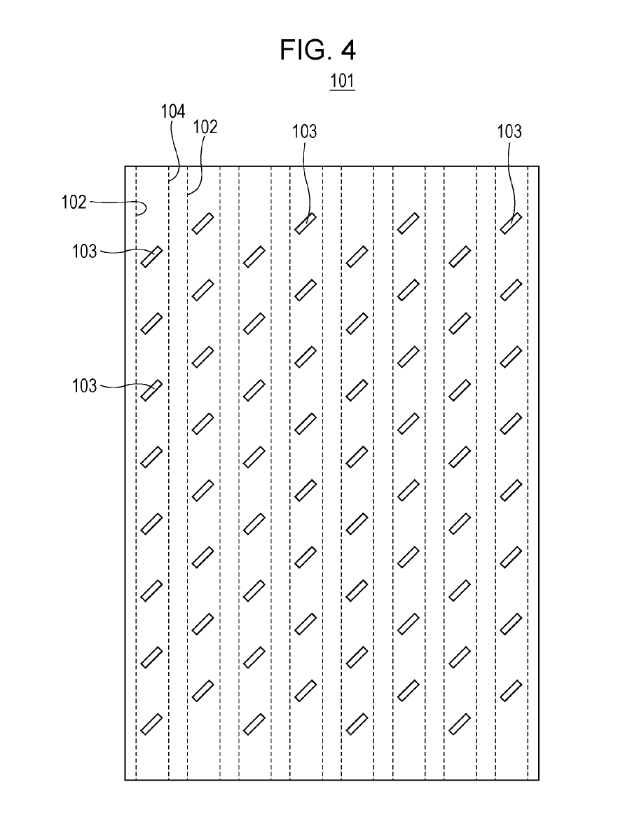

FIG. 4 is a plane developed view of a conformal waveguide slot array antenna device 101 according to a second modification. In the conformal waveguide slot array antenna device 101 according to the second modification, a plurality of slot antennas 103 are formed on each narrow wall surface of a radiation surface 110 so as to be parallel to each other and be arranged to form an angle of approximately 45 degrees with respect to a longitudinal direction of the narrow wall surface. Accordingly, the conformal waveguide slot array antenna device of FIG. 4 has a polarization plane of a linearly polarized wave which forms an angle between a horizontally polarized wave and a vertically polarized wave. Here, adjacent slot antennas 103 are segregated from each other by one wave length and each of the slot antennas 103 has a length of a half wave length in the longitudinal direction.

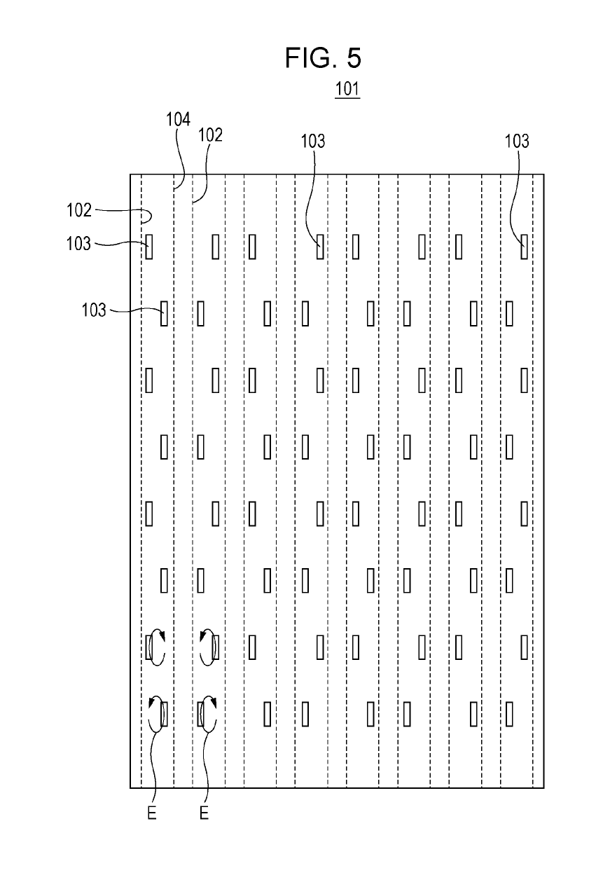

FIG. 5 is a plane developed view of a conformal waveguide slot array antenna device according to a third modification. In the conformal waveguide slot array antenna device according to the third modification, a plurality of slot antennas 103 are formed such that a longitudinal direction of the slot antennas 103 and a longitudinal direction of narrow wall surfaces are parallel to each other. Further, as illustrated by an arrow of an electric field E, the slot antennas 103 are formed to make phases of adjacent branches (slot array antennas) reversed to each other. Here, slot antennas 103 adjacent to each other in the longitudinal direction in each slot array antenna are formed to be segregated from each other by a predetermined distance and be alternately arranged on both end portions of a narrow wall surface in a short side direction. Thus, rotation directions of electric fields E of the adjacent slot antennas 103 are opposed to each other. Accordingly, potential difference of adjacent branches (slot array antennas) becomes zero in the central part of the lateral wall 104. Therefore, the array antenna device can be operated by a vertically polarized wave (linearly polarized wave) even though each narrow wall surface of the radiation surface 110 and the waveguide 102 are not coupled in a precisely-opposed fashion. Consequently, it is possible to manufacture a radiation surface 110 and a waveguide 102 as separate parts and to omit precise connection in assembling of the radiation surface 110 and the waveguide 102. Thus, a manufacturing process is simplified and mass productivity is increased advantageously.

Here, FIG. 4 and FIG. 5 are plane developed views in which a width of each of the slot array antennas is identical to that in a plain surface of the conformal waveguide slot array antenna device 101 of FIG. 1.

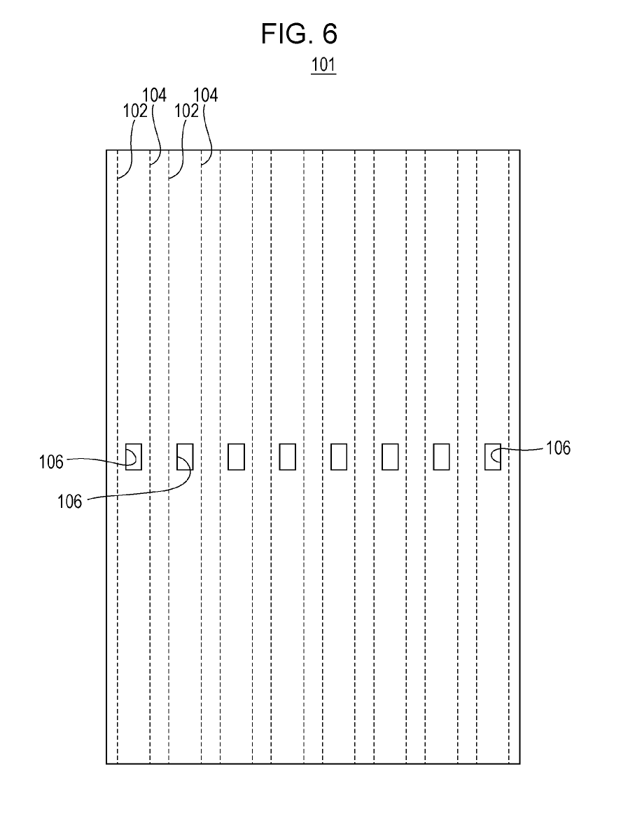

FIG. 6 is a bottom view illustrating the power supply portions 106 provided on a bottom surface of the conformal waveguide slot array antenna device of FIG. 1. As illustrated in FIG. 6, the power supply portions 106 having a rectangular pillar shape are formed in the central part in the longitudinal direction of each of the waveguides 102 (lengthwise direction of FIG. 6).

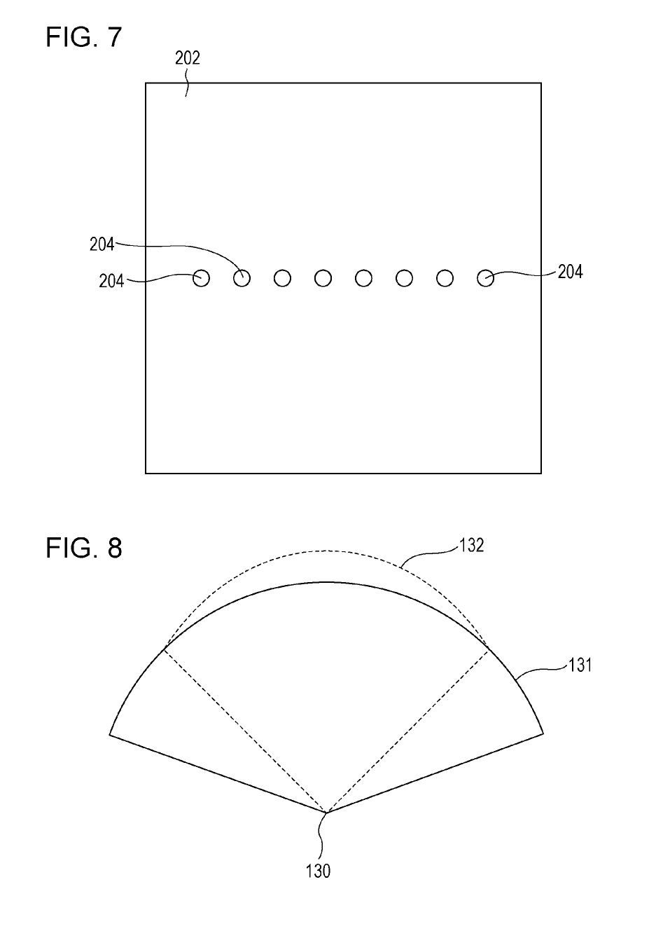

FIG. 7 is a plan view illustrating an upper surface of the integrated circuit (IC) 202 of FIG. 2 and FIG. 3. As illustrated in FIG. 7, a plurality of connection terminals 204 are formed on an upper portion of the integrated circuit 202.

FIG. 8 illustrates a radiation pattern 131 of the conformal waveguide slot array antenna device of FIG. 1 and a radiation pattern 132 of a waveguide slot array antenna device of a comparative example. Referring to FIG. 8, reference numeral 130 denotes a radiation reference point, and an angle of the radiation pattern 131 of the conformal waveguide slot array antenna device according to Embodiment 1 is wider (wide angle) than an angle of the radiation pattern 132 of the waveguide slot array antenna device of the comparative example.

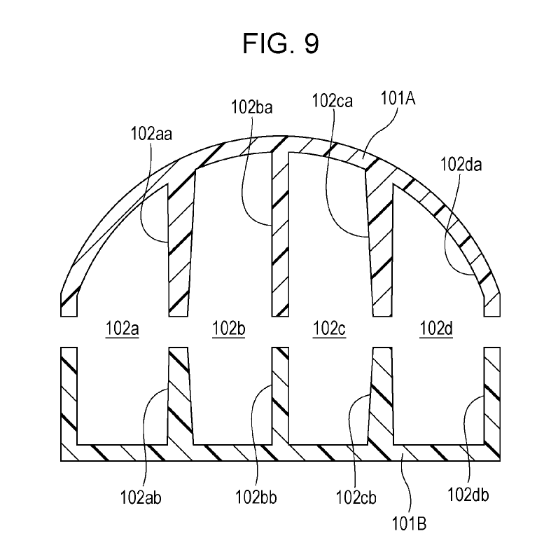

FIG. 9 is a longitudinal sectional view illustrating the configuration of a case in which the conformal waveguide slot array antenna device 101 of FIG. 1 is manufactured by a resin molding method.

The conformal waveguide slot array antenna device 101 of FIG. 1 is divided into two as an upper antenna portion 101A and a lower antenna portion 101B at a dividing position on a level, on which a current in excitation is approximately zero, in the longitudinal direction of a waveguide (lengthwise direction of FIG. 9). A waveguide 102a is divided into two as an upper waveguide 102aa and a lower waveguide 102ab, a waveguide 102b is divided into two as an upper waveguide 102ba and a lower waveguide 102bb, a waveguide 102c is divided into two as an upper waveguide 102ca and a lower waveguide 102cb, and a waveguide 102d is divided into two as an upper waveguide 102da and a lower waveguide 102db. Here, each of the upper waveguides 102aa to 102da and the lower waveguides 102ab to 102db may be formed so that a short side width thereof is decreased from the dividing position toward a waveguide end portion through the inside of the waveguide. In this case, after the upper antenna portion 101A and the lower antenna portion 101B are formed by the resin molding method and are bonded with each other, a metal thin film is formed on an inner surface of the waveguide with metal plating such as Cu plating. Thus, the waveguides 102a to 102d are formed.

In the resin molding method, a waveguide body is formed with resin such as epoxy resin and liquid crystal polymer by using a metal mold and surface treatment is performed with plating with respect to the inner surface of the formed waveguide. Here, the waveguide body may be formed by a three-dimensional printer.

A waveguide is formed by using the resin molding method and the plating method as described above. Accordingly, a manufacturing process can be simplified and manufacturing cost can be substantially reduced compared to a case in which a waveguide is formed by bending metal, for example, as performed in related art. Further, power is supplied by a waveguide, being able to transmit a radio signal with low loss. Furthermore, the radiation surface 110 is formed to have a conformal shape as described above, being able to achieve a wide angle as described with reference to FIG. 8.

FIG. 10 is a lateral view illustrating an antenna element interval of the conformal waveguide slot array antenna device 101 of FIG. 1. A reason why it is possible to achieve a larger element interval in the conformal waveguide slot array antenna device 101 than that of a waveguide slot array antenna device which is not conformal is described below.

Generally, grating lobes easily occur in an array antenna when an element interval is increased. Therefore, it is necessary to make an element interval small so as to attain wide-range scanning in a beam directivity direction while suppressing an occurrence of grating lobes in the configuration of related art in which antenna elements are arranged on a flat surface at even interval.

On the other hand, an antenna surface is formed to be physically inclined with respect to a beam directivity direction in the conformal waveguide slot array antenna device according to the present embodiment, being able to set a plurality of beam reference directions. Accordingly, it is possible to set a narrow scanning range of an antenna element with respect to each of the beam reference directions.

In particular, in a case in which a conformal waveguide slot array antenna device includes eight branches, it is enough for each of beam reference directions A, B, and C to cover a range of 40 degrees so as to cover a scanning range of 120 degrees as illustrated in FIG. 10. That is, slot array antennas 101a, 101b, 101c, and 101d are chiefly operated to cover ±20 degrees around the beam reference direction A. Similarly, slot array antennas 101c, 101d, 101e, and 101f are chiefly operated to cover ±20 degrees around the beam reference direction B. Further, slot array antennas 101e, 101f, 101g, and 101h are chiefly operated to cover ±20 degrees around the beam reference direction C. Thus, it is possible to narrow a beam scanning range with respect to each of the beam reference directions A, B, and C. Therefore, even when an antenna element interval is increased, it is possible to form a preferable beam directivity of high gain and a narrow half value angle without generating grating lobes.

Here, the beam reference direction represents the approximately front direction with respect to a sub array which is composed of at least two antenna elements in the whole array antenna. The case in which the number of beam reference directions is three has been described in the present embodiment, but the number is not limited to three. For example, four or more beam reference directions may be provided. In the present disclosure, three or more beam reference directions which are different from each other are provided on the radiation surface 110 and four or more slot array antennas are assigned to each of the beam reference directions. Thus, a predetermined beam directivity can be obtained.

Here, in a case of array antennas of related art which are arranged on a flat surface at even interval, the beam reference direction is a single direction which is the front direction.

When a part of sub arrays which face an opposite direction to a beam reference direction is not excited, power consumption of the entire device can be reduced. For example, the slot array antennas 101f, 101g, and 101h are not excited while exciting the slot array antennas 101a, 101b, 101c, 101d, and 101e with respect to the beam reference direction A. Accordingly, it is possible to reduce power consumption compared to a case in which all slot array antennas are excited. Here, slot array antennas which are not excited are not limited to those described above.

FIG. 11 is a lateral view for explaining that guide wavelengths are made even in each waveguide of the conformal waveguide slot array antenna device of FIG. 1. In FIG. 11, the waveguides 102a and 102b are separated by the lateral wall 104a and the waveguides 102c and 102d are separated by the lateral wall 104b.

In a case in which the lateral walls 104a and 104b which form the waveguides 102a to 102d are formed so that the waveguides 102a to 102d are parallel to each other, the length of the wall near an end portion is shorter than the length of the wall near the center of FIG. 11 (lengthwise direction of FIG. 11). Therefore, wavelengths in the waveguides are substantially different from each other, whereby it is difficult to cover a wide range of frequency.

A guide wavelength λ_{c} of a waveguide is generally represented by formula (1) when the length in the longitudinal direction of the waveguide (lengthwise direction of FIG. 11) is denoted as a. In this case, λ₀ denotes a free space wavelength. Formula (1) diverges in a case of λ₀=2a, so that a>λ₀/2 is set. Further, in a case of a>λ₀, a high order mode is generated. Therefore, the length a in the longitudinal direction is designed within the range represented by formula (2). On the other hand, when an antenna element is formed on a narrow wall surface, the length b in the short side direction is designed to be shorter than λ₀/2 as represented in formula (3) so as to suppress a high order mode.

$$\begin{matrix}{λ}_{c} = \frac{{λ}_{0}}{\sqrt{1 - {( \frac{{λ}_{0}}{2 a} )}^{2}}} & ( 1 ) \\ \frac{{λ}_{0}}{2} < a < {λ}_{0} & ( 2 ) \\ b < \frac{{λ}_{0}}{2} & ( 3 )\end{matrix}$$

Therefore, part or all of the lateral walls 104 are formed such that the lateral walls 104 are not orthogonal to the power supply surface as illustrated in FIG. 11. Thus, the length of the walls near the end portions is increased. Accordingly, it is possible to make guide wavelengths approximately even, being able to cover a wide range of frequency. In particular, the length of the wall near the center is a1, while the length of the wall of the waveguide on the end portion is a2. The length a2 is shorter than the length a1, but the length a2 is longer than the height a3 of the antenna surface. Consequently, it is possible to suppress increase of the guide wavelength λ_{c}.

Here, in the present disclosure, the shape of the wall is not limited to that illustrated in FIG. 11. For example, when the width of a base of a wall in the configuration of two parts, which are an upper part and a lower part, is set to be larger than the width on a dividing position as illustrated in FIG. 9, it is possible to increase the length a while setting the length b to be λ₀/2 or smaller. Thus, the guide wavelength of a waveguide on an end portion can be made longer than that of related art.

### Embodiment 2

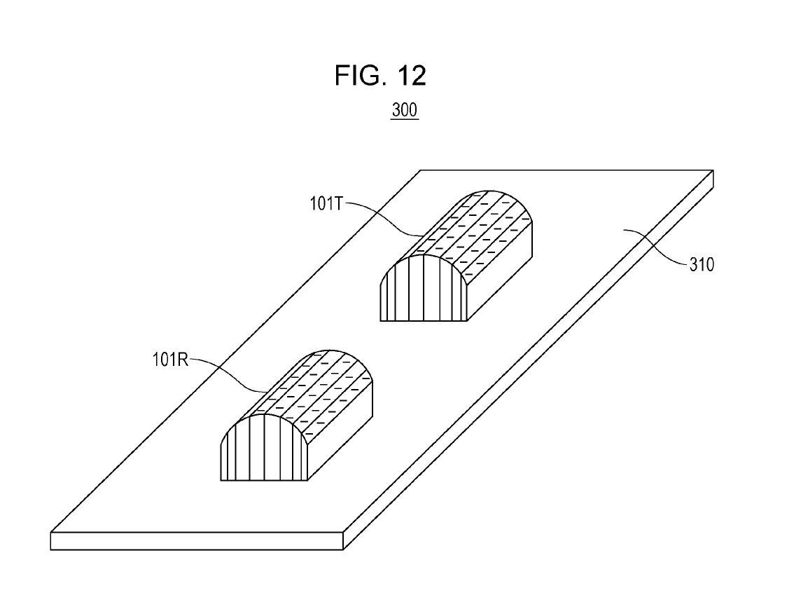

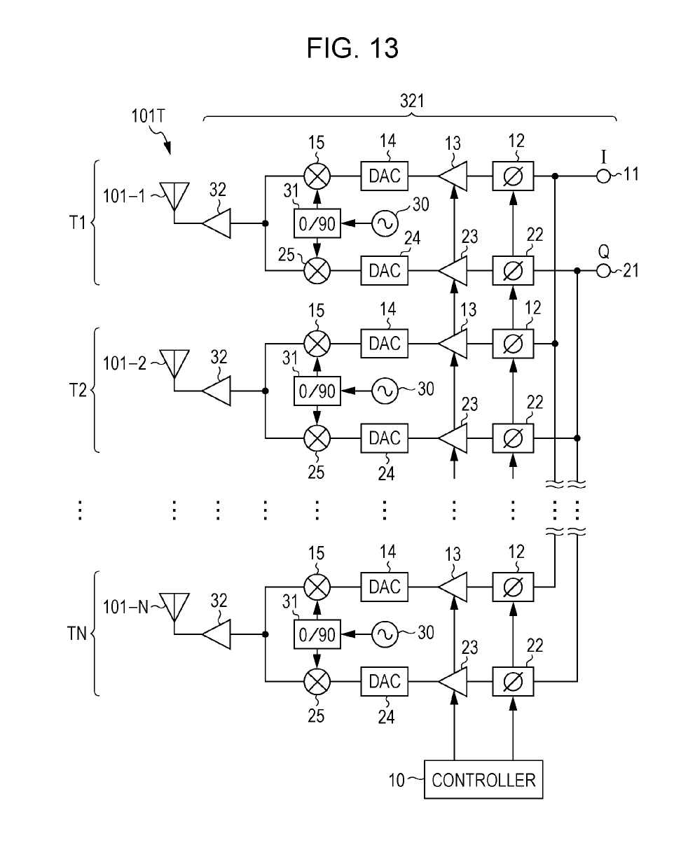

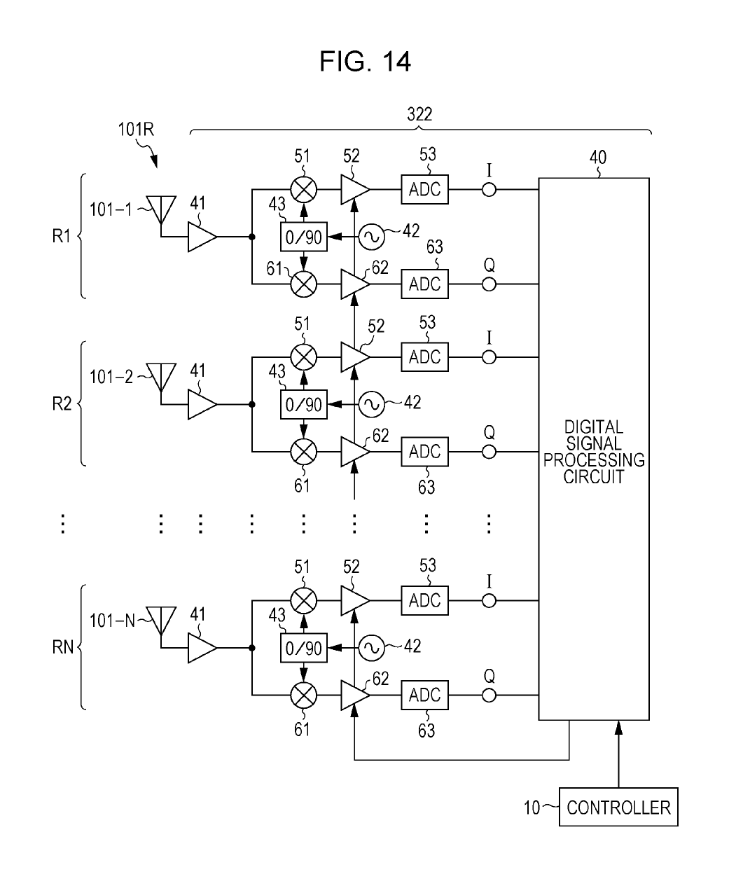

FIG. 12 is a perspective view illustrating an external appearance of a radar device 300 according to Embodiment 2. The radar device 300 according to Embodiment 2 is configured to include two pieces of conformal waveguide slot array antenna devices 101 according to Embodiment 1 as shown in FIG. 12. The two pieces of conformal waveguide slot array antenna devices 101 are respectively used as a transmission antenna 101T and a reception antenna 101R. A radio frequency (RF) module for the radar device 300 is configured such that the transmission antenna 101T and the reception antenna 101R are aligned on a substrate 310 and a radio transmission circuit 321 shown in FIG. 13 and a radio reception circuit 322 shown in FIG. 14 are provided on a lower portion of the substrate. This radar device 300 is used for collision avoidance of vehicles, for example. The radar device 300 transmits a radio signal by using a radio wave in a sub-millimeter wave or millimeter wave band, for example, and receives a reflection signal reflected from a predetermined reflection object such as a vehicle and a pedestrian so as to detect presence/absence of a reflection signal, a distance and a direction to the reflection object, and so on.

FIG. 13 is a block diagram illustrating the configuration of the radio transmission circuit 321 for the transmission antenna 101T of FIG. 12. In FIG. 13, the transmission antenna 101T is composed of N pieces of slot array antennas 101-1 to 101-N (N is a plural number) and the radio transmission circuit is composed of N pieces of transmission branch circuits T1 to TN. Between an I baseband digital signal and a Q baseband digital signal which are orthogonal to each other, the I baseband digital signal is inputted into a phase shifter 12 of each of the transmission branch circuits T1 to TN via a signal input terminal 11 and the Q baseband digital signal is inputted into a phase shifter 22 of each of the transmission branch circuits T1 to TN via a signal input terminal 21.

In each of the transmission branch circuits T1 to TN, the phase shifter 12 shifts a phase of an inputted digital signal by a predetermined phase shift amount, which is controlled by a controller 10, to output the digital signal, of which the phase is shifted, to a variable amplifier 13, and the variable amplifier 13 amplifies the inputted digital signal by a predetermined amplification factor, which is controlled by the controller 10, to output the amplified digital signal to a DA converter 14. The DA converter 14 DA-converts the inputted digital signal into an analog signal to output the analog signal to a mixer circuit 15. Further, the phase shifter 22 shifts a phase of an inputted digital signal by a predetermined phase shift amount, which is controlled by the controller 10, to output the digital signal, of which the phase is shifted, to a variable amplifier 23, and the variable amplifier 23 amplifies the inputted digital signal by a predetermined amplification factor, which is controlled by the controller 10, to output the amplified digital signal to a DA converter 24. The DA converter 24 DA-converts the inputted digital signal into an analog signal to output the analog signal to a mixer circuit 25.

A local oscillator 30 generates a local oscillation signal having a predetermined transmission local oscillation frequency to output the local oscillation signal to a phase shift circuit 31. The phase shift circuit 31 omits phase shift of the inputted local oscillation signal to output the local oscillation signal, in which the phase shift is omitted, to the mixer circuit 15 as a first local oscillation signal, while the phase shift circuit 31 shifts a phase of the inputted local oscillation signal by 90 degrees to output the local oscillation signal, of which the phase is shifted, to the mixer circuit 25 as a second local oscillation signal. The mixer circuit 15 is provided with a high-pass filter or a band pass filter and high-frequency-converts (up-converts) a first radio signal, which is obtained by mixing an analog signal inputted from the DA converter 14 with the first local oscillation signal, to output the first radio signal to a power amplifier 32. The mixer circuit 25 is provided with a high-pass filter or a band pass filter and high-frequency-converts (up-converts) a second radio signal, which is obtained by mixing an analog signal inputted from the DA converter 24 with the second local oscillation signal, to output the second radio signal to the power amplifier 32. The power amplifier 32 mixes the first and second radio signals to amplify the power and radiates the obtained radio signal via the slot antenna 103.

In the radio transmission circuit 321 configured as described above, the slot array antennas 101-1 to 101-N of respective transmission branch circuits T1 to TN constitute the transmission antenna 101T which is a conformal waveguide slot array antenna device, as a whole. This transmission antenna 101T radiates a radio signal, which is obtained by mixing first and second radio signals, by a radiation angle which is controlled by the controller 10. In the radar device 300, the radiation angle is scanned by the controller 10 in a predetermined rotation speed.

FIG. 14 is a block diagram illustrating the configuration of the radio reception circuit for the reception antenna 101R of FIG. 12. In FIG. 14, the reception antenna 101R is composed of N pieces of slot array antennas 101-1 to 101-N (N is a plural number) and the radio reception circuit is composed of N pieces of reception branch circuits R1 to RN. A radio signal received by the reception antenna 101R is received by the slot array antennas 101-1 to 101-N.

A received radio signal is inputted into mixer circuits 51 and 61 via a low-noise amplifier 41 in each of the reception branch circuits R1 to RN. A local oscillator 42 generates a local oscillation signal having a predetermined reception local oscillation frequency to output the local oscillation signal to a phase shift circuit 43. The phase shift circuit 43 omits phase shift of the inputted local oscillation signal to output the local oscillation signal, in which the phase shift is omitted, to the mixer circuit 51 as a third local oscillation signal, while the phase shift circuit 43 shifts a phase of the inputted local oscillation signal by 90 degrees to output the local oscillation signal, of which the phase is shifted, to the mixer circuit 61 as a fourth local oscillation signal. The mixer circuit 51 is provided with a low-pass filter or a band pass filter and low-frequency-converts (down-converts) a first baseband signal, which is obtained by mixing a radio signal inputted from the low-noise amplifier 41 with the third local oscillation signal, to output the first baseband signal to an AD converter 53 via a variable amplifier 52 of which an amplification factor is controlled by a digital signal processing circuit 40. The AD converter 53 AD-converts a first baseband signal, which is inputted and is an analog signal, into an I digital baseband signal to output the I digital baseband signal to the digital signal processing circuit 40. The mixer circuit 61 is provided with a low-pass filter or a band pass filter and low-frequency-converts (down-converts) a second baseband signal, which is obtained by mixing a radio signal inputted from the low-noise amplifier 41 with the fourth local oscillation signal, to output the second baseband signal to an AD converter 63 via a variable amplifier 62 of which an amplification factor is controlled by the digital signal processing circuit 40. The AD converter 63 AD-converts a second baseband signal, which is inputted and is an analog signal, into a Q digital baseband signal to output the Q digital baseband signal to the digital signal processing circuit 40.

In the radio reception circuit 322 configured as described above, the slot array antennas 101-1 to 101-N of respective reception branch circuits R1 to RN constitute the reception antenna 101R which is a conformal waveguide slot array antenna device, as a whole. This reception antenna 101R receives a reflected radio signal which is generated such that a radio signal radiated from the transmission antenna 101T described above is reflected at a reflection object such as a vehicle, for example. The digital signal processing circuit 40 which is controlled by the controller 10 calculates and outputs presence/absence of a received radio signal, a reception angle (direction), and so forth on the basis of a plurality of I digital baseband signals and a plurality of Q digital baseband signals, which are inputted into the digital signal processing circuit 40, while controlling respective amplification factors of the variable amplifiers 52 and 62. Accordingly, it is possible to detect whether another vehicle or pedestrian exists within a predetermined distance and to detect a distance and a direction to a detected object.

The radar device 300 is described in Embodiment 2 above, but the present disclosure is not limited to the radar device 300 and may be a radio communication device provided with a general communication radio transmission circuit and a general communication radio reception circuit.

Further, the configuration is not limited to that described in this embodiment. For example, the number of branches of the transmission antenna and the reception antenna may be changed.

Here, the transmission antenna may be operated for transmission beam forming and the reception antenna may be operated for digital beam forming. Accordingly, even when the number of branches of the transmission antenna is increased such as 8 or 16, for example, the number of transmission ports for the IC is one. Thus, a circuit is simplified.

### Summary of Embodiments

An array antenna device according to a first aspect of the present disclosure includes a plurality of slot array antennas which are arranged and each of which includes a plurality of slot antennas and a radiation surface, the radiation surface having a conformal shape, and a plurality of waveguides each of which supplies respective power to each of the plurality of slot array antennas.

In an array antenna device according to a second aspect of the present disclosure, surface treatment is performed with plating with respect to an inner surface of the waveguides in the array antenna device according to the first aspect.

In an array antenna device according to a third aspect of the present disclosure, waveguides adjacent to each other among the plurality of waveguides are separated from each other by a lateral wall, and the plurality of waveguides are divided into two in a longitudinal direction of the waveguides and a short side width of the waveguides is decreased from a dividing position toward a waveguide end portion in the array antenna device according to the first or second aspect.

In an array antenna device according to a fourth aspect of the present disclosure, the plurality of slot array antennas are respectively formed on a narrow wall surface of the plurality of waveguides in the array antenna device according to the first, second, or third aspect.

In an array antenna device according to a fifth aspect of the present disclosure, each of the plurality of slot array antennas includes a plurality of slot antennas which are parallel to each other in the array antenna device according to the first to fourth aspects.

In an array antenna device according to a sixth aspect of the present disclosure, the plurality of slot antennas are formed on an end portion of a short side direction of the narrow wall surface along a longitudinal direction of the narrow wall surface of the waveguides in such a manner that rotation directions of electric fields of adjacent slot antennas in adjacent slot array antennas are opposed to each other in the array antenna device according to the fifth aspect.

In an array antenna device according to a seventh aspect of the present disclosure, part or all lateral walls which separate the plurality of waveguides are formed such that the lateral walls are not orthogonal to a power supply surface in the array antenna device according to the first to sixth aspects.

In an array antenna device according to an eighth aspect of the present disclosure, the plurality of slot array antennas have three or more beam reference directions which are different from each other on a radiation surface, and a predetermined beam directivity is obtained by using four or more slot array antennas with respect to each of the beam reference directions in the array antenna device according to the first to seventh aspects.

An array antenna device according to a ninth aspect of the present disclosure includes at least two array antenna devices according to any one of the first to eighth aspects, in which one array antenna device is used as a transmission array antenna device, and the other array antenna device is used as a reception array antenna device.

A radio communication device according to a tenth aspect of the present disclosure includes the array antenna devices according to the ninth aspect, a radio transmission circuit which is connected to the transmission array antenna device, and a radio reception circuit which is connected to the reception array antenna device.

In a radio communication device according to an eleventh aspect of the present disclosure, the radio communication device is a radar device in the radio communication device according to the tenth aspect.

As described in detail above, a slot array antenna device according to the present disclosure is capable of radiating radio waves in lower loss and increasing a radiation angle, and can be more simply manufactured, compared to a conformal antenna composed of a planar antenna.

What is claimed is:

1. An array antenna device comprising:
a plurality of slot array antennas which are arranged and each of which includes a plurality of slot antennas and a radiation surface, the radiation surface having a conformal shape; and
a plurality of waveguides each of which supplies respective power to each of the plurality of slot array antennas.

2. The array antenna device according to claim 1, wherein surface treatment is performed with plating with respect to an inner surface of the plurality of waveguides.

3. The array antenna device according to claim 1, wherein
waveguides adjacent to each other among the plurality of waveguides are separated from each other by a lateral wall, and
the plurality of waveguides are divided into two in a longitudinal direction of the waveguides and a short side width of the waveguides is decreased from a dividing position toward a waveguide end portion.

4. The array antenna device according to claim 1, wherein the plurality of slot array antennas are respectively formed on a narrow wall surface of the plurality of waveguides.

5. The array antenna device according to claim 1, wherein each of the plurality of slot array antennas includes a plurality of slot antennas which are parallel to each other.

6. The array antenna device according to claim 5, wherein the plurality of slot antennas are formed on an end portion of a short side direction of the narrow wall surface along a longitudinal direction of the narrow wall surface of the waveguides in such a manner that rotation directions of electric fields of adjacent slot antennas in adjacent slot array antennas are opposed to each other.

7. The array antenna device according to claim 1, wherein part or all lateral walls which separate the plurality of waveguides are formed such that the lateral walls are not orthogonal to a power supply surface.

8. The array antenna device according to claim 1, wherein
the plurality of slot array antennas have three or more beam reference directions which are different from each other on a radiation surface, and
a predetermined beam directivity is obtained by using four or more slot array antennas with respect to each of the beam reference directions.

9. A device comprising,
at least two array antenna devices, each of the at least two array antenna devices comprising:
a plurality of slot array antennas which are arranged and each of which includes a plurality of slot antennas and a radiation surface, the radiation surface having a conformal shape; and
a plurality of waveguides each of which supplies respective power to each of the plurality of slot array antennas,
wherein
one of the at least two array antenna devices is used as a transmission array antenna device, and
the other of the at least two array antenna device is used as a reception array antenna device.

10. A radio communication device comprising,
at least two array antenna devices, each of the at least two array antenna devices comprising:
a plurality of slot array antennas which are arranged and each of which includes a plurality of slot antennas and a radiation surface, the radiation surface having a conformal shape; and
a plurality of waveguides each of which supplies respective power to each of the plurality of slot array antennas,
a radio transmission circuit which is connected to a transmission array antenna device, and
a radio reception circuit which is connected to a reception array antenna device,
wherein one of the at least two array antenna devices is used as the transmission array antenna device, and the other of the at least two array antenna device is used as the reception array antenna device,

11. The radio communication device according to claim 10, wherein the radio communication device is a radar device.
